(19) United States
(12) Patent Application Publication
(10) Pub. No.: US 2012/0109345 A1
(43) Pub. Date: May 3, 2012

(54) Music Atlas Systems and Methods

(76) Inventor: Randall A. Gilliland, Hampton, VA (US)

(21) Appl. No.: 12/938,374

(22) Filed: Nov. 2, 2010

(51) Int. Cl. G06F 17/00

(52) U.S. Cl. 700/94

(57) ABSTRACT

The Music Atlas System includes at least one web-enabled and GPS-enabled mobile device configured to communicate with various websites on the World Wide Web (WWW). The Music Atlas application of the present invention is configured to create playlists for a user based on the user's preferences, such as, current location or a selected route and destination, birthplace of an artist or of the song, associated lyrics, landmarks, concert schedules and other information. The playlist may be a function of the current location, city, state, region or country. A geographically relevant playlist would include songs associated with a geographic location (city, town, current location, etc.). The Music Atlas application may be configured to deliver information specific to the song or artist to the mobile device.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to media presentation systems.

II. Background

Currently, iPhones have iPod MP3 player functionality. Some iPhones when purchased include MP3 files. The iPhone may also be equipped with a global positioning system (GPS) application or a locating position system that displays routes on a display screen. There is not a system that marries the GPS information with music and other entertainment media to selectively deliver geographically relevant music and associated information to the user.

There is a continuing need for a Music Atlas application that can be downloaded onto an iPhone or other web-enabled and GPS-enabled mobile device. The Music Atlas application is configured to allow the user to build geographically relevant playlists and retrieve artist information based on either the current location of the mobile device or iPhone or a travel route taken.

### SUMMARY

The aforementioned problems, and other problems, are reduced, according to exemplary embodiments, by the music atlas systems and methods herein below configured to generate a road trip playlist based on a road trip path or geographical location of a web-enabled and locating position-enabled mobile device, such as a cellular phone, satellite phone, iPhone, etc.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The exemplary embodiments, objects, uses, advantages, and novel features are more clearly understood by reference to the following description taken in connection with the accompanying figures wherein:

FIG. 1 illustrates a block diagram of the Music Atlas System in accordance with some embodiments of the present invention;

FIG. 2 illustrates a block diagram of an exemplary media device having a Music Atlas Application in accordance with some of the embodiments of the present invention;

FIG. 3 illustrates a block diagram of a mobile device with a Music Atlas application in accordance with some embodiments of the present invention;

FIG. 4 illustrates a block diagram of a road trip playlist database;

FIG. 5 illustrates a flowchart of a process to generate a playlist for a particular road trip; and

FIG. 6 illustrates a flowchart of a process to play songs on the playlist during the road trip.

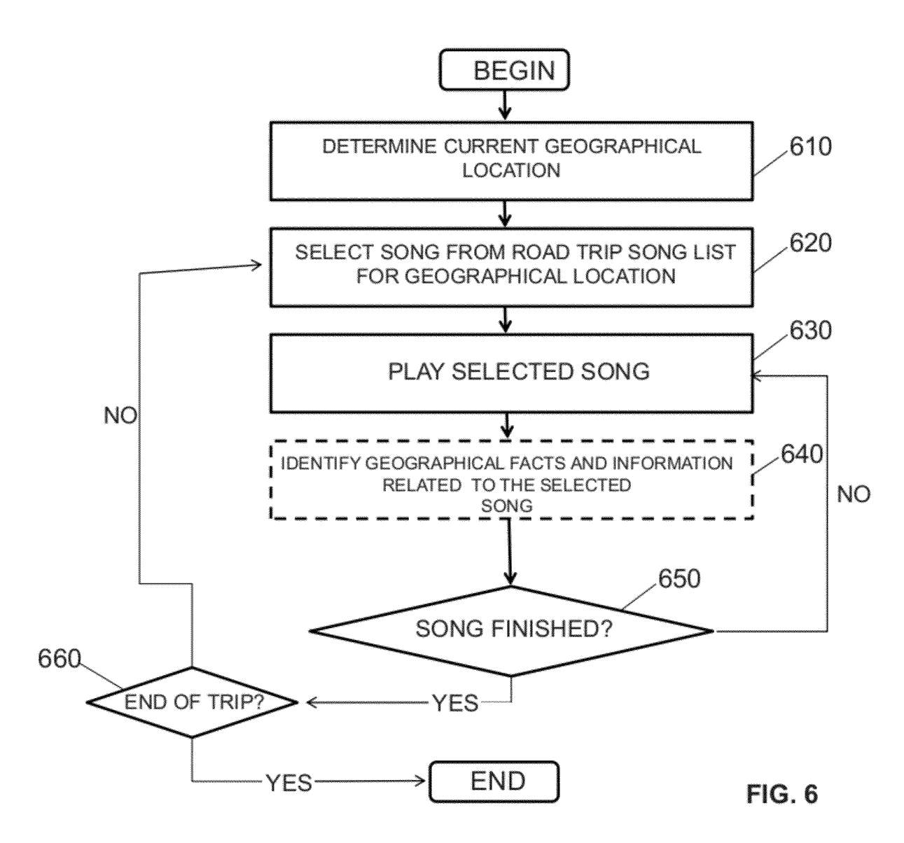

FIG. 7 illustrates a block diagram of an iPhone device that interacts with the Music Atlas application in accordance with some of the exemplary embodiments.

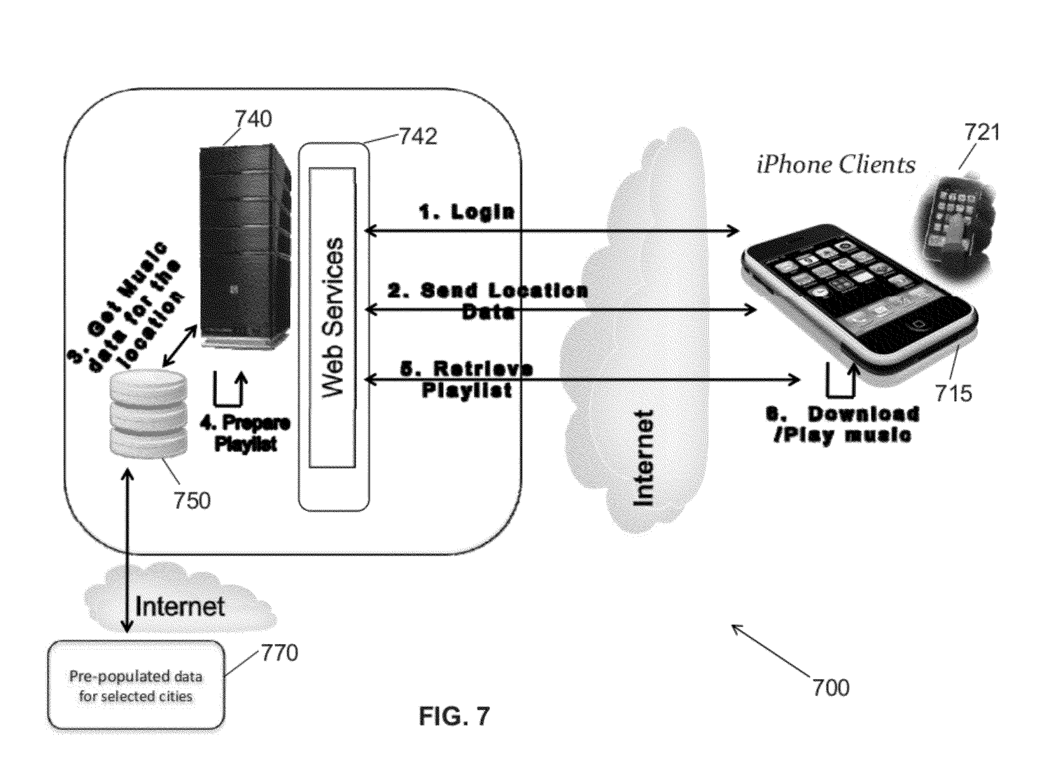

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

The functions of the various elements shown in the figures, including functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those skilled in the art further understand that the exemplary hardware, software, processes, methods, and/or operating systems described herein are for illustrative purposes and, thus, are not intended to be limited to any particular named manufacturer.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The Music Atlas System includes at least one web-enabled and GPS-enabled mobile device such as a cellular phone, satellite phone, smart phone, iPhone, etc. configured to communicate with various websites on the World Wide Web (WWW). The various websites may include one or more of iTunes or some other music storehouse configured to allow users to download and store music over the WWW. In the exemplary embodiment, the mobile device should also include or be compatible with MP3 functionality. Other hand-held devices that include or configured to include GPS applications, web-enabled and MP3 functionality may be used.

Currently, the iTunes website provides an online service to enable users to access playlists, purchase at least one selected song and download the selected music/song through various graphical user interfaces (GUIs). The web-enabled and GPS-enabled mobile device (hereinafter referred to as the “mobile device”) is configured to store one or more songs in the mobile device for selective playback. Some mobile devices include memory to store large amounts of music. For example, some iPhones are available with 8 Gbytes, 16 Gbytes, or 32 Gbytes of memory for storing volumes of music.

The Music Atlas application of the present invention is configured to create playlists for a user based on the user's current location or a selected route and destination. The playlist may be a function of the current location, city, state, region or country. A geographically relevant playlist would include songs associated with a geographic location (city, town, current location, etc.). The Music Atlas application may be configured to deliver information specific to the song or artist to the mobile device.

The Music Atlas application of the present invention is configured to create playlists for a user based on the user's current location or a road trip (entered route) for business or personal reasons. The songs presented would include songs having relevancy to geographic locations along the path of the road trip. For example, if the artist of a song is born in a city along the road trip path, such song would be included in the playlist. The Music Atlas application may be configured to generate a map of music-related points of interest along the path of a road trip or around a user's current location. The map may include a birthplace of an artist, a grave site of an artist, school or home of an artist or other landmarks associated with an artist or song associated with the road trip playlist or a geographically based playlist.

The Music Atlas application of the present invention is configured to create a playlist based on a birthplace of the artist or band or place of origin of the song. The playlist may be created from songs prestored in the user's mobile device or other memory devices with music that may be interfaced with the Music Atlas application. The playlist may be created from song suggestions developed by a web-based search conducted by the Music Atlas application.

The Music Atlas application provides a search engine of playlists to select songs by lyrics associated with cities, states, countries traveling in wherein the user may select whether they want to search on cities, states, countries, etc.

The Music Atlas application is configured to generate short bio information on bands or artists associated with songs in the road trip playlist.

The Music Atlas application is configured to identify landmarks (schools, grave sites, museums) associated with songs along the path of the road trip or places to visit along the road trip path.

The Music Atlas application is configured to identify concert schedules, products or other information related to songs or artists in a Music Atlas playlist.

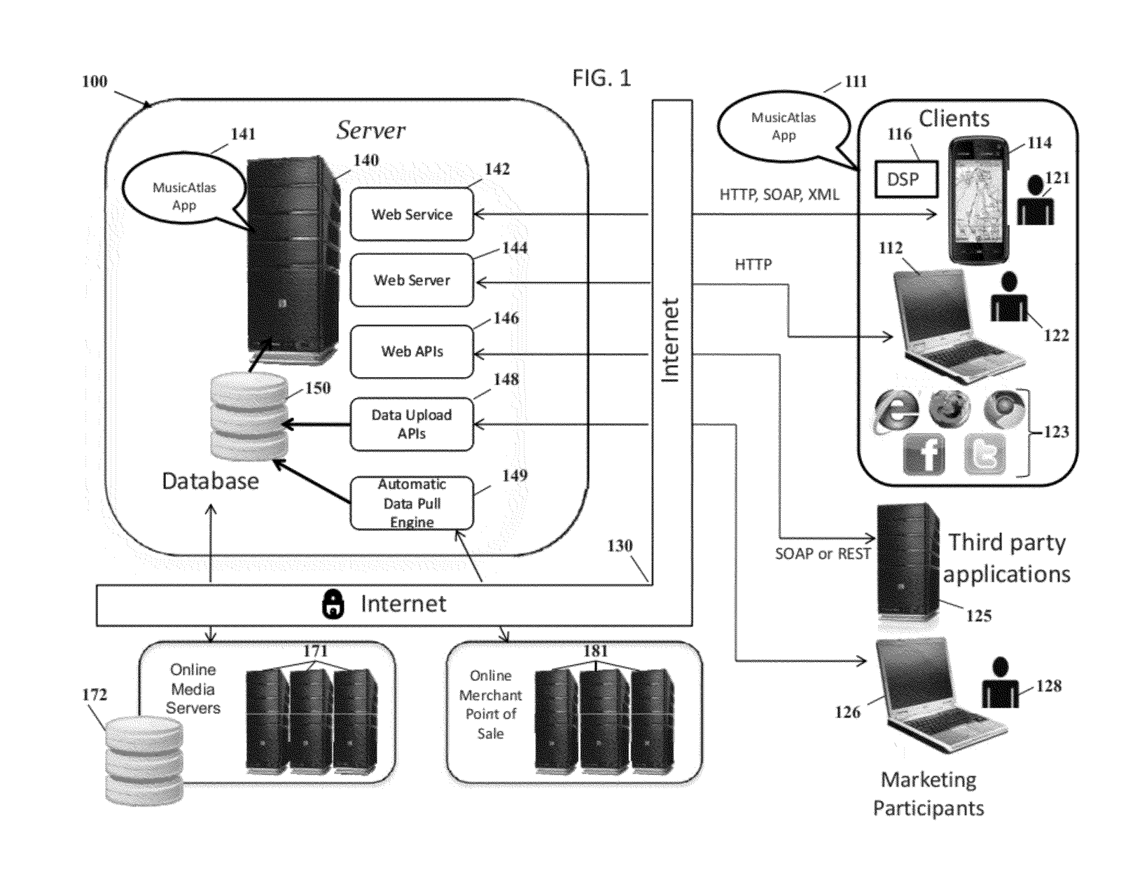

FIG. 1 illustrates a block diagram of the Music Atlas System in accordance with some embodiments of the present invention. The system includes one or more mobile devices in communications (wired or wireless) 112, 114 with an iTunes website or some other music storehouse website having a database 150 or collection of music or music-related information. The system may include one or more websites or other communication methods that provide music trivia information such as concert schedules, artist biographical information, song place or origin, etc. The artist biographical information may include the place of birth for one or more band members or artist, artist or band place or origin, current residences of artist or band members, and other trivia associated with a song that is a function of a geographic location.

The mobile device is configured to communicate with the iTunes website or some other music or music-related information storehouse website using the WWW. The user may communicate with the iTunes website via another device and transfer music files to the mobile device.

The mobile device or some other computing device may communicate with the website via the World Wide Web (WWW), Internet or Intranet. The communication medium may be compatible with WiFi communications, IEEE 802.11 communications, 2 G, 2.5 G, 3G, 4G, XDSL, DSL, etc. Alternatively, the mobile device may communicate with the Music Atlas application via the Public Switch Telephone Network (PSTN) or via a satellite communications network.

The system is configured to allow web-enabled devices (laptops, personal computers or the like) to communicate with the WWW to receive playlists that can be later transferred (downloaded/uploaded) to the mobile devices. The web-enabled device will allow the user to develop a playlist and select musical points of interest based on a variety of criteria, including a road trip route. The user may transfer the playlist and map points of interest to the mobile device to play such songs based on the current geographical location.

The user may download playlists and map routes and points of interest on to their mobile device, in order to allow the application to perform some of its functions when there is a loss of cellular service or wireless data connection.

The system is configured to operate with wired or wireless devices. The devices may include a cellular phone, a terminal, personal computer (PC), a wirelessly-equipped personal digital assistant (PDA), a wireless communications device, a laptop computer. The wireless communications may be a Code Division Multiple Access (CDMA) system, a Global System for Mobile Communications (GSM) system, satellite communications, cellular communication, mobile communications, or some other system.

The iTunes website and other websites comprise a web-based platform configured to execute a set of programs to interface with the devices, computers, and/or through the WWW. The web-based platform includes one or more processors, computers, servers to execute the set of programs for carrying out access to the website, set up and store user information, or operations to perform iTunes service.

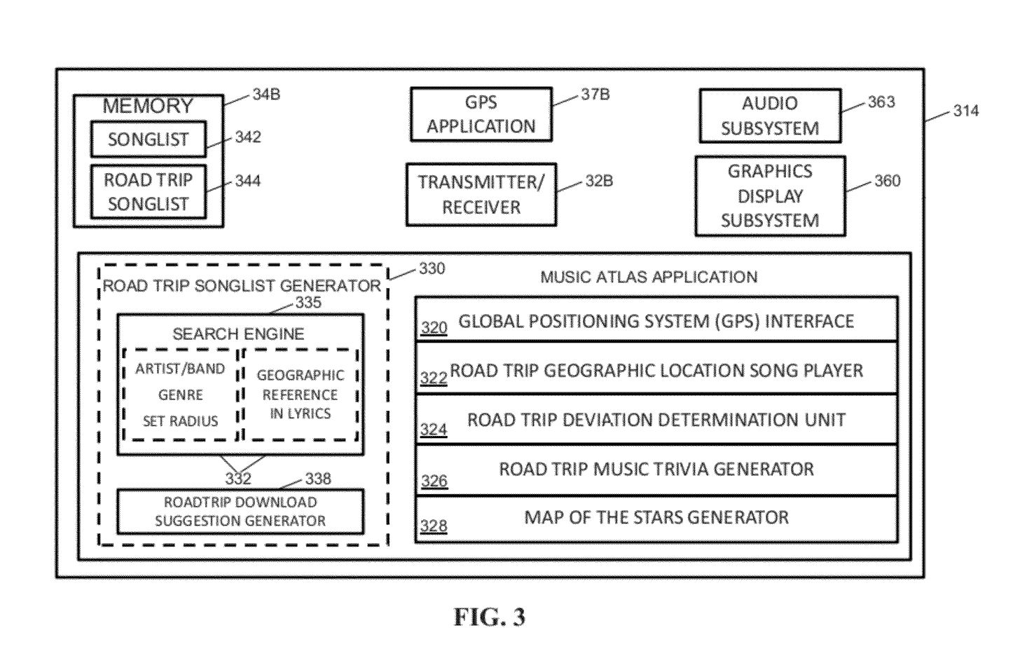

The mobile device is configured with a Music Atlas application, as will be described in FIG. 3. The system is configured to allow mobile devices to install the Music Atlas application and receive updates via the WWW. The Music Atlas application is configured to generate playlists, make suggestions for music downloads, provide music-related facts, and generate points of interest based on the mobile device's current location, projected location, or locations within a selected radius of the current location or projected route of the mobile device.

The exemplary embodiment of the present invention includes a music trivia database, interface to any existing music trivia database or other information that can be collected to build playlists based on or categorized based on a geographic location or proximity to geographic locations.

According to some of the embodiments, a cellular phone and iPhone are shown traveling two different paths. The cellular phone may be traveling the path associated with Cities 1 and 2 in State 1 and City 3 in State 2. The iPhone may be traveling along a path associated with City x in State 3 and Cities y and z in State 4. The playlist may include songs associated with the city and state they are currently located, when traveling along the path. The songs delivered to the user may change from city to city and state to state.

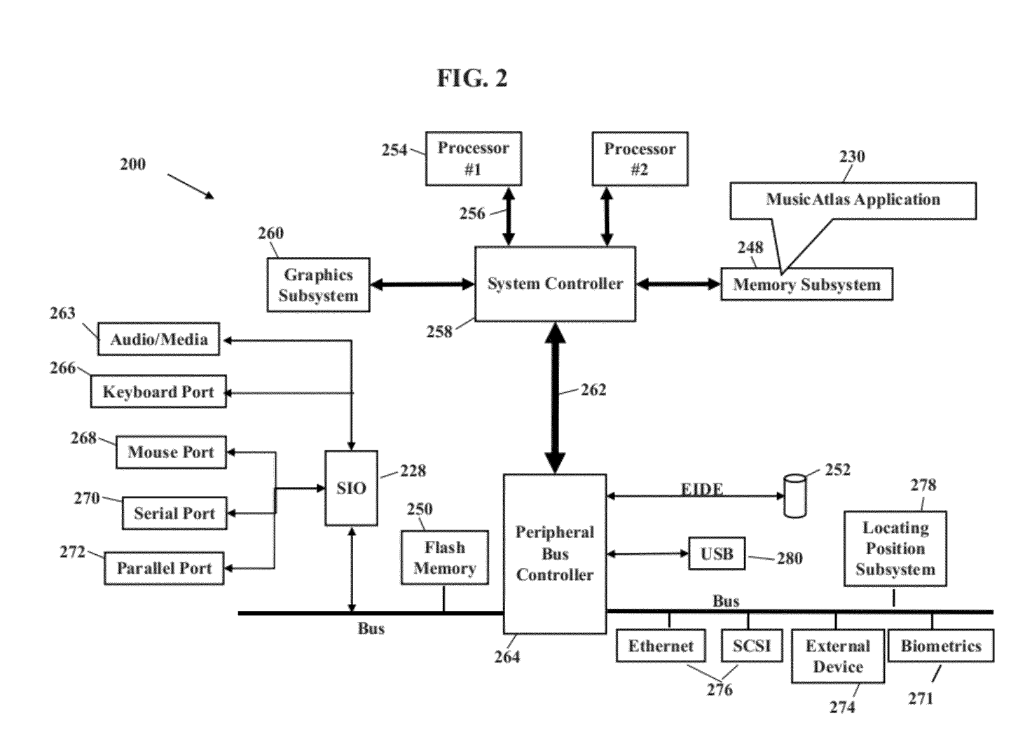

FIG. 2 is a block diagram showing the Music Atlas Application residing in a mobile communications system 200 and/or smart phone system. The Music Atlas Application operates within a system memory device. The Music Atlas Application, for example, is shown residing in a memory subsystem 248. The Music Atlas Application, however, could also reside in flash memory 250 or peripheral storage device 252. The computer system also has one or more central processors 254 executing an operating system. The operating system, as is well known, has a set of instructions that control the internal functions of the computer system. A system bus 256 communicates signals, such as data signals, control signals, and address signals, between the central processor and a system controller 258 (typically called a “Northbridge”). The system controller provides a bridging function between the one or more central processors, a graphics subsystem 260, the memory subsystem, and a PCI (Peripheral Controller Interface) bus 262. The PCI bus is controlled by a Peripheral Bus Controller 264. The Peripheral Bus Controller (typically called a “Southbridge”) is an integrated circuit that serves as an input/output hub for various peripheral ports. These peripheral ports could include, for example, a keyboard port 266, a mouse port 268, a serial port 170 and/or a parallel port 272 for a video display unit, one or more external device ports 274, and networking ports 276 (such as SCSI or Ethernet). The Peripheral Bus Controller could also include an audio subsystem 263.

The system memory device (shown as memory subsystem, flash memory, or peripheral storage device) may also contain an application program. The application program cooperates with the operating system and with a video display unit (via the serial port and/or the parallel port) to provide a Graphical Customer Interface (GUI). The Graphical Customer Interface provides a convenient visual and/or audible interface with the customer or user of the device 200. As is apparent to those skilled in the art, the selection and arrangement of the play list may be programmed over a variety of alternate mediums, such as, for example, a voice-activated menu prompt, an interactive session with an telecommunications network administrator, and the like.

FIG. 3 illustrates a block diagram of a mobile device with a Music Atlas application in accordance with some embodiments of the present invention. The mobile device is a web-enabled and GPS-enabled mobile device. The mobile device may include a transmitter/receiver section, GPS unit, a mapping application, and memory with songs including a song playlist database. The mobile device may include a display to display a map of musical points of interest or other landmarks or bio information and a speaker to hear the music data file.

The memory also includes a Music Atlas application having a road trip playlist generator, a GPS interface, a map of musical points of interest, a music trivia generator, a road trip deviation determination unit, and road trip geographical location song player. The road trip playlist generator includes a search engine that allows the user to search for songs based on a plurality of search criteria constrained by a geographic location, path or route, and other user-selected constraints, such as genre or time period (musical era). The search criteria include an artist/band and a birthplace, geographical reference in lyrics, song place or origin, genre, and/or radius from the route path. The module may include a road trip download suggestion generator to suggest songs not stored by the user for use in the road trip. The search engine searches for songs based on a user selected criteria.

The mobile device may be configured to transfer the song to be played by the mobile device to a vehicle's on-board radio system or other mobile devices in proximity to the mobile device with the stored geographically based playlist. Thus, the mobile device may share the song with others (mobile devices) in proximity, in accordance with copyright law and other rules (for example, iTunes Store rules about file sharing). The mobile device may also transfer trivia information presented to the user based on the geographical location or other songs in the playlist.

The Music Atlas application is configured to display map points, routes, etc. using the device's own mapping applications or interfaces (if available), as well as the GPS system. For example, on the iPhone, the Music Atlas application would be configured to interact with the “Compass” and “Maps” applications in order to track locations and display routes and points of interest.

In an exemplary embodiment, the user will have the option to allow the Music Atlas application to automatically update the playlist for a roadtrip. For example, as a current location changes, the list may be automatically updated by discarding the least geographically relevant songs/info and refreshing the list with newly relevant songs or data. This functionality is configured to would allow the playlist to stay at a reasonable size, say 20 songs that are most relevant to the current GPS location. The size of the persistent, refreshing list will be customizable by the user. Alternatively, the user could decide to load the entire playlist and info for the entire planned route. Again, the size of the list would be customizable, allowing the user to constrain it, say to 100 or 200 songs or points of interest.

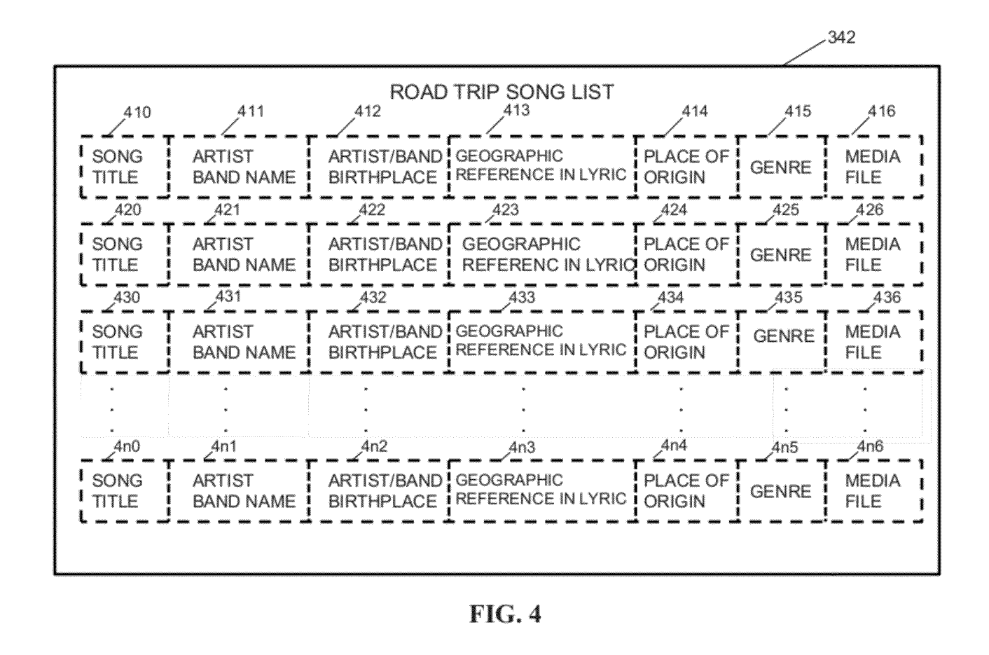

FIG. 4 illustrates a block diagram of a road trip playlist database. Once the Music Atlas application generates a road trip or current location playlist, said list is stored in a database or memory. One or more memory locations may be assigned to a current road trip and saved for later recall and playing of the songs on the road trip playlist during the road trip or at any other time as desired.

The road trip playlist includes a plurality of songs identified by a song profile. The song profile includes one or more of a music title, artist/band name, artist/band birthplace, geographical reference in lyrics, place or origin of the song, genre, and other criteria based on the information available in a music file or database. The music file being played by the mobile device based on the current geographical location or proximity of the mobile device to landmarks associated with the road trip. Each song has a song title. The songs selected for the road trip may be selected based on the title being associated with a geographical location or proximity to a geographical location in a road trip path. The artist/band name may have a birthplace, house, or other related landmark associated with a geographical location or proximity to a geographical location in the road trip path.

The song may be selected based on lyrics within the song being associated with a geographical location or proximity to a geographical location in the road trip path.

The song may be selected based on the place or origin of the song.

As can be appreciated, elements of the song profile may vary. For example, the song genre may be part of the song profile. Landmarks associated with the song may be added to the song profile and/or other trivia information such as an artist's bio information, concert schedule for the artist/band, etc. The song profile may be stored for later recall during the road trip or at other times. One or more data elements of the song profile may be used to generate a map of musical points of interest that overlays the device's native or web-based mapping application.

During the route the Music Atlas application may automatically present trivia or data elements of the song profile to the user based on the current geographical location.

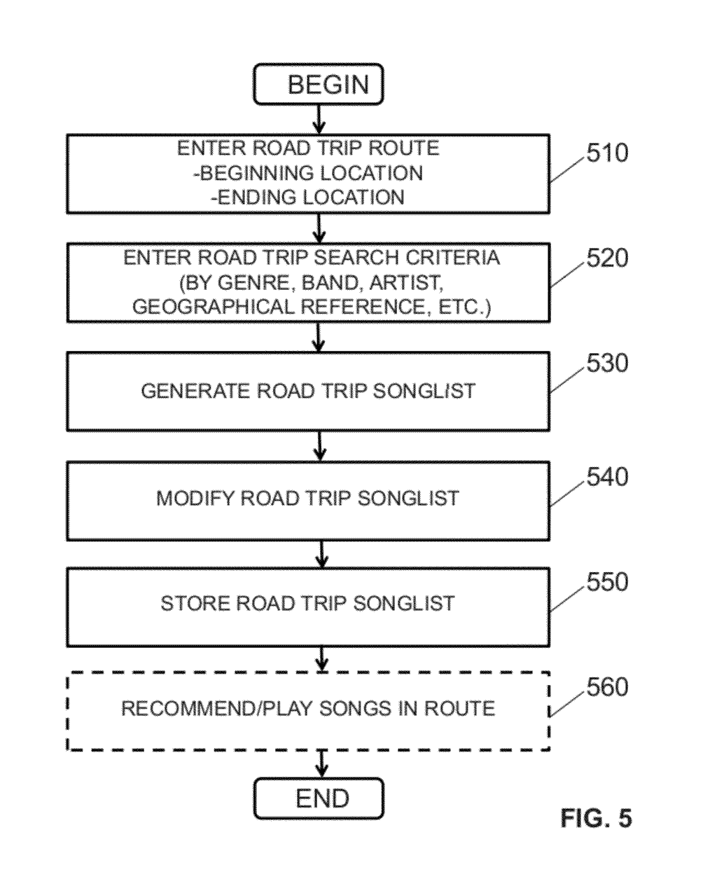

FIG. 5 illustrates a flowchart of a process to generate a playlist for a particular road trip using the Music Atlas application. As can be appreciated, one or more of the blocks or steps in the flowchart may be performed in either the same order depicted or a different order. Additionally, one or more blocks or steps may be omitted or performed contemporaneously with other blocks or steps. Furthermore, one or more blocks or steps may be added in order to allow the Music Atlas application to perform its functions as described throughout this document.

The user would enter a trip route including a beginning location and an ending location. A road trip route would be determined such as generated by GPS systems. Alternatively, the user can elect not to enter a road trip route, and run the Music Atlas application based only on current GPS location, without entering a specific destination or generating a road trip route. After entering the road trip route or enabling “current location mode,” the user may enter search criteria. The user may also select an all inclusive search. For example, the user may select a genre or two or more genres. Songs related to the genre having any association with the geographical locations along the road trip route would be identified to the user.

Once a road trip playlist is generated, the user may have the ability to modify the playlist to eliminate any undesirable songs or songs that may require a download. The user may also customize the playlist by adding one or more songs stored in the memory of the device, or acquired through download or purchase from a music database. The road trip playlist is stored in the mobile device. As the user travels and the location of the mobile device changes, the playlist may be updated as songs in the database may be played or recommended (shown in phantom as being optional) for selection by the user. For example, the user may select not to play a particular song on the playlist even though the current location and locations associated with the song correspond or match. The Music Atlas application is configured to conduct a web-based search and/or a search of prestored music in the mobile device.

While the above description is a function of a road trip, the set of blocks or steps may be used to generate a playlist based on a single geographic location, such as where a user lives, works, or is currently located. Thus, the songs may be developed based on a radius and not necessarily on a road trip route.

The application, as used on the mobile device or another web-enabled device, will allow the user to select a location and set a radius in order to receive notifications. Based on parameters selected by the user, the application will notify the user about new events and points of interest as they are updated in the database. For example, a user could elect to be notified via Music Atlas when specific band is performing a concert within 100 miles of their home. The user can also customize the way they receive these notifications from Music Atlas, for example via email, SMS, or “push notifications” on their mobile device.

FIG. 5 illustrates a flowchart of a process to play songs on the playlist during the road trip. The process determines a current geographical location of the mobile device. The process then selects a song from the road trip song list for the current geographical location. The process plays the selected song. Optionally, trivia such as geographical facts and other information related to the song would be presented or displayed to the user. A determination is made whether a song has finished playing. If the song is not finished playing, the process loops back to continue playing the selected song. However, once a song is finished playing, a determination is made whether the trip has ended. If the trip has ended, the process ends. However, if the road trip has not ended, the process loops back to select another song based on the geographical location.

As can be appreciated, one or more additional steps may be added. For example, a determination may be made if any more songs are in the song list. If no more songs are in the play list, the process may end or repeat previously played songs. Alternately, an option to seek additional songs by the Music Atlas application may be allowed.

In addition, if a song, selected from the play list or found by the Music Atlas application, is not owned by the user, the option to purchase the song may be presented. If the user selects to purchase the song, the song will then be downloaded and played. If the users do not select to purchase the song, the Music Atlas application will select another song from the road trip song list.

Additionally, during the process, the user may display a map of musical points of interest associated music with the road trip playlist. The Music Atlas application will use the device's native mapping applications or web-based mapping applications. Additionally, other trivia may be added for artists associated with a geographical location that may not be part of the road trip playlist.

While the above description is described in relation to mobile devices, the system and Music Atlas application may be adapted to a vehicle's on-board radio system and GPS system. The music may be from satellite radio (SAT radio), AM/FM radio, digital radio or prerecorded music that may be stored and/or access via the vehicle's on-board radio system. The Music Atlas application would interface with the vehicle's GPS system and radio to develop playlists based on the vehicle's current geographical system.

While the above description describes musical selection and play list based on the user's preferences, tastes, and location, the system and method may be adapted to other media, such as, for example, film, news, art, or sports. As the user travels along their route they are presented with a tailored array of media and points of interest (e.g., childhood home of a famous movie actor, etc.). The application generates this content by analyzing the overall trip route, real-time location, user preferences, the device's media library, and other sources of data authorized by the user. For example, a user who is interested in HBO and is traveling to the Black Hills of South Dakota could be presented with POIs such as the historical location of the Gem Saloon or the gravesite of one of the characters from the HBO series “Deadwood.” The media playlist could dynamically update to include a YouTube clip of a documentary about the famous sheriff, Seth Bullock.

Initially, the methods and systems of the present invention may be populated with a significant amount of POIs generated from various sources of third-party data. However, the users will power the application's growth by adding new POIs and supplementary information to the Atlas. The application will be available across a variety of platforms—smart phones, web browsers, in-vehicle navigation systems (land, air, water), and set-top boxes for Internet televisions. Part of the application's appeal is that users can enjoy a rich experience even when their physical location is static. Although the application headlines as a travel companion, users can explore the globe and create uniquely themed multimedia playlists from their desktop.

According to some of the embodiments, additional functionality includes the ability to “thumbs up” or “thumbs down” a particular POI or pre-selected media (e.g., song). Likes and dislikes would incrementally adjust and refine the trip criteria. The user has the option to toggle between Trip Mode and Freeform. In trip mode, the POIs will be generated using the Trip criteria and current location. Freeform mode will allow the user to see what's around them based solely on current location, without any filtering. That way, users can take full advantage of the app's functionality without having to enter a destination or any other criteria.

According to some of the exemplary embodiments, the user integrates the application with his/her favorite services to enhance the overall experience. For example, integration with a Pandora account would extend a user's song and data pool tremendously, as they would not be constrained to the music stored locally on the device. Likewise, integration with Foursquare and Facebook would provide the opportunity for a rich social experience and enhanced music discovery, with trip sharing, photos, comments, event destinations, check-ins, etc. Partnering with national organizations such as the Rock and Roll Hall of Fame would help increase the number and quality POIs and also generate publicity. And, as mentioned above, the music discovery piece is enhanced by integration with the iTunes Store.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A device, comprising:
a processor in communication with a memory device to access and select one or more media files to present to the device; and
a battery for providing a power source to the device.

2. The device of claim 1, further comprising a speaker for presenting audio.

3. The device of claim 2, wherein the processor communicates with the memory device to access and select one or more data files to simultaneously play with one or more media files.

4. The device claim 1, further comprising an application module operable for creating a user profile of one or more presentation parameters associated with genre, geographic location, geographic reference, place of origin, band name, artist name, entertainer name, athlete's name, song title, movie title, athletic team, name of city, timing intervals, recent downloads of digital or audio media, digital media associated with a detected communications address, user identification or other electromagnetic signature of a proximate communications device, the digital media comprising at least one of digital data, audio data, or data configured to graphical effects to the media device.

5. The device of claim 1, further comprising:
a wireless transceiver for transmitting and receiving communications signals to a wireless device.

6. The device of claim 5, wherein the wireless device comprises at least one of:
an iphone,
a remote control device,
a mobile phone,
a cellular phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

7. The device of claim 1, further comprising:
a network connection for transmitting and receiving communications signals between the device and an external communications network.

8. The device of claim 7, wherein the external communications network comprises a communication services provider, the communications service provider processing a selection for presentation media to the device, and the communications service provider billing a user communications address.
